(19) United States
(12) Patent Application Publication
(10) Pub. No.: US 2008/0264940 A1
(43) Pub. Date: Oct. 30, 2008

(54) Fluid container with detachable utensil holder

(76) Inventor: Kenneth David Crooks, Bronx, NY (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/789,750

(22) Filed: Apr. 25, 2007

(51) Int. Cl. B05B 11/00

(52) U.S. Cl. 220/23.83

(57) ABSTRACT

The present invention provides an apparatus that allows a cleaning utensil to be stored and transported with a cleaning container and to be easily removed to clean desired surfaces as needed. In one embodiment of the invention, the apparatus has a ring assembly that can be attached to a cleaning container and a receptacle for the cleaning utensil. The ring assembly can be a solid ring constructed of the same material as the receptacle for the cleaning utensil. The ring assembly can also be a strap, a clip, or any other material that allows the receptacle to be attached to the fluid container. In some embodiments of the present invention, the receptacle can be a box, a clip, a clamp, or any other holder to attach the cleaning utensil to the fluid container. Other embodiments of the present invention do not require a ring assembly. In such embodiments, the cleaning utensil can be detachably connected to the fluid container with a hook and loop fastener. Some embodiments of the present invention utilize a hanging arm to connect the ring assembly and the receptacle.

### BACKGROUND OF THE INVENTION

1. Field of the Invention

The present invention relates to cleaning fluid containers and cleaning utensils, and more particularly to a fluid container provided with a cleaning utensil and a cleaning utensil carrier providing immediate and easy access to such cleaning utensil.

2. Background

For storage purposes, cleaning supplies are often thrown together in buckets. Cleaning solutions and cleaning utensils, such as sponges, are typically stored in a haphazard manner, for instance thrown together in a bucket, in a cabinet, or in entirely separate spaces, such that locating them when one wishes to use them often becomes a rather inconvenient burden. It would therefore be desirable to provide a system that allows easy access to cleaning utensils that are to be used in conjunction with cleaning solutions, and preferably that stores them together to eliminate the need to search separately for those items when their use is required.

Some fluid containers have been known to have sponges integrally attached to their openings. For example, some cleaning liquid containers have a sponge permanently joined to the container's cap so as to allow the sponge to be soaked by the liquid stored in the container as the container is tilted. The sponge can then be used as an applicator for the cleaning solution. Shoe cleaning liquids use this type of system to apply cleaning solutions to shoes. However, the sponges are typically not removable from the cap of such containers, and their use typically requires that the bottle be pointed downward during use to allow the polish to soak the sponge to allow its application. Such devices are therefore not suitable for cleaning large or variously oriented surfaces.

Other combinations of containers and sponges can be found in the prior art. For example, there are dispensers of liquid cosmetic solutions that allow for carrying foam pads with the dispenser. These types of dispensers are built with specific compartments for the foam applicators. They include apparatus with multiple layers, such as one for a base, one for the holder and another for the container. Some include slides onto which the foam applicator can be attached. However, such containers are typically specially manufactured with an interior compartment for holding a sponge. It would be desirable to provide an apparatus that could be used with or retrofit to existing containers that allows the user to keep cleaning utensils with their respective cleaning solutions and, as a result, provide cleaning utensils that can be easily removed and utilized.

### SUMMARY OF THE INVENTION

The present invention provides a solution to the above and other problems by providing an apparatus that allows a cleaning utensil to be stored and transported with an existing or new cleaning container. The apparatus can be placed on a number of different containers and allows the utensil to be easily removed for cleaning as needed. In one embodiment of the invention, the apparatus has a ring that can be attached to a cleaning container and a receptacle for the cleaning utensil. The ring assembly can be a solid ring constructed of the same material as the receptacle for the cleaning utensil. The ring can also be a strap, a clip, or any other material that allows the receptacle to be attached to the fluid container. In some embodiments of the present invention, the receptacle can be a box, a clip, a clamp or any other means to attach the cleaning utensil to the fluid container. Other embodiments of the present invention do not require a ring assembly. In such embodiments, the cleaning utensil can be detachably connected to the fluid container with a hook and loop fastener. Additionally, some embodiments of the present invention utilize a hanging arm to connect the ring assembly to the receptacle. Other and additional objects of this invention will become apparent from consideration of this entire specification.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 illustrates an embodiment of the present invention where a cleaning utensil holder is attached to a fluid container.

FIG. 2a illustrates a top view of the utensil holder shown in FIG. 1 where a sealing material inside a ring assembly has a number of incisions that allow the utensil holder to be securely attached to the fluid container.

FIG. 2b illustrates a top view of the utensil holder shown in FIG. 1 where a sealing material inside a ring assembly has an opening for securing the holder to the fluid container.

FIG. 3 illustrates a front view of the utensil holder shown in FIG. 1, where a cleaning utensil receptacle is attached to the ring assembly by a hanging arm.

FIG. 4 illustrates a side view of the utensil holder shown in FIG. 1, where a cleaning utensil receptacle is attached to the ring assembly by a hanging arm.

FIG. 5 illustrates an embodiment of the present invention with a clip for holding a cleaning utensil.

FIG. 6 illustrates an embodiment of the present invention where the fluid container's neck is generally aligned with the body of the container.

FIG. 7 illustrates an embodiment of the present invention where the fluid container's body has a rounded neck.

FIG. 8 illustrates an embodiment of the present invention where a hanging arm connects to the ring assembly at an angle.

### DETAILED DESCRIPTION

The invention summarized above and defined by the enumerated claims may be better understood by referring to the following description, which should be read in conjunction with the accompanying drawings in which like reference numerals are used for like parts. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

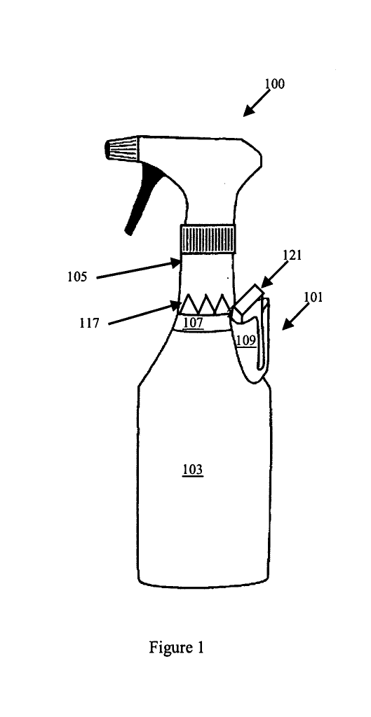

One embodiment of the present invention is illustrated in FIG. 1. A cleaning apparatus 100 includes a cleaning utensil holder 101 and a fluid container 103. The cleaning utensil holder 101 is securely attached to the container's neck 105, or any other portion of the fluid container 103 suitable for the cleaning utensil holder 101. The cleaning utensil holder 101 consists of a connecting end or ring assembly 107 that is attached to a cleaning utensil receptacle 109. The receptacle 109 can be directly and permanently attached to the ring assembly 107, it can be attached through a hanging arm 111(as shown in FIGS. 3 and 4), or it can be detachably attached by a hook and loop fastener or similar fastener. The receptacle holds a cleaning utensil 121 such as a sponge, a brush, or any other utensil suitable for use with the solution in the container 103.

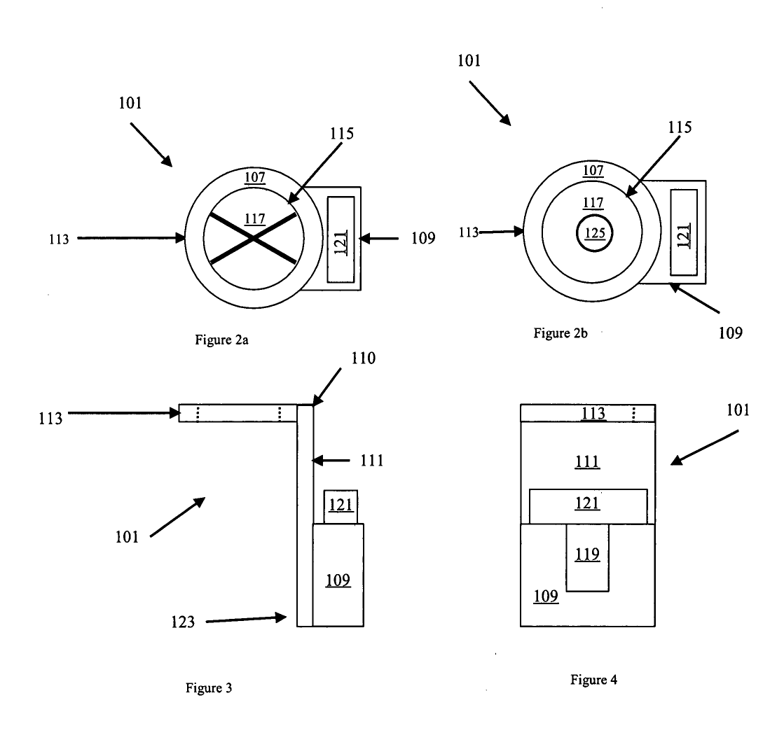

The ring assembly 107 can be constructed from multiple materials such as plastics, metals, acrylics, nylon straps, hook and loop fasteners and others. The ring assembly 107 has an outer ring 113 and an inner ring 115 as shown in FIGS. 2a and 2b. The outer ring 113 can have different configurations, e.g., circle, oval, rectangle, and any other configuration that does not interfere with the use of the fluid container 103 and the cleaning utensil 121. The inner ring 115 can have different configurations that generally mirror the outline of the cleaning container's neck 105. The internal portion of the inner ring 115 has a diameter that is sufficiently large to fit around the neck 105 of the fluid container 103, or the position on the container 103 where the cleaning utensil holder 101 is to be placed.

In one embodiment of the present invention, the ring assembly 107 can be adjusted to fit the fluid container 103. In another embodiment, the ring assembly is not adjustable, in which case, the inner ring 115 may contain additional sealing material 117 that allows the cleaning utensil holder 101 to remain in place. The additional sealing material 117 can be constructed from any elastomeric compound that allows the cleaning utensil holder 101 to be securely attached to the fluid container 103.

As illustrated in FIG. 2a, two or more incisions can be made in the additional sealing material 117 allowing the neck 105 of the fluid container 103 to fit within the inner ring 115 and be securely held in place by the sealing material 117. The incisions create triangular, or other geometrically shaped, portions of the elastomeric compound 117 that shift upward as the cleaning utensil holder 101 is placed on the fluid container 103. These geometric portions of the elastomeric compound 117 prevent the utensil holder 101 from being inadvertently removed from the fluid container 103. Alternatively, the sealing material 117 can be constructed from an 5 elastomeric compound with an opening 125 of a smaller diameter than the neck 115 of the fluid container 103. The opening would extend from a top side of the ring assembly 107 to the bottom side of the ring assembly 107. The neck 115 of the fluid container 103 can be pushed through the opening in the elastomeric compound forming a tight seal around the neck 105 of the fluid container 103. The seal from the elastomeric compound holds the cleaning utensil holder 101 in place. In yet another embodiment of the present invention, the ring assembly 107 is not a complete circle but has an opening that forms a clamp that can be snapped onto the neck 105 of the fluid container 103.

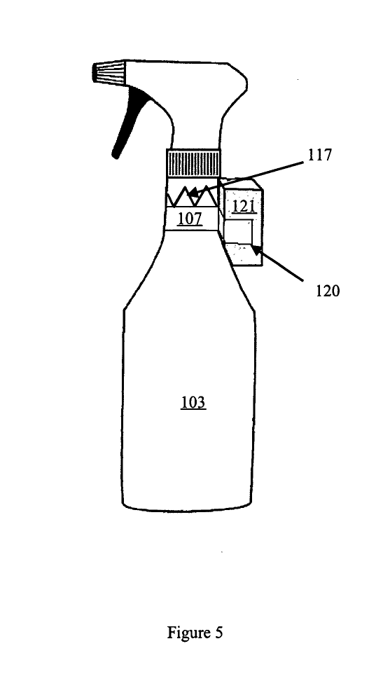

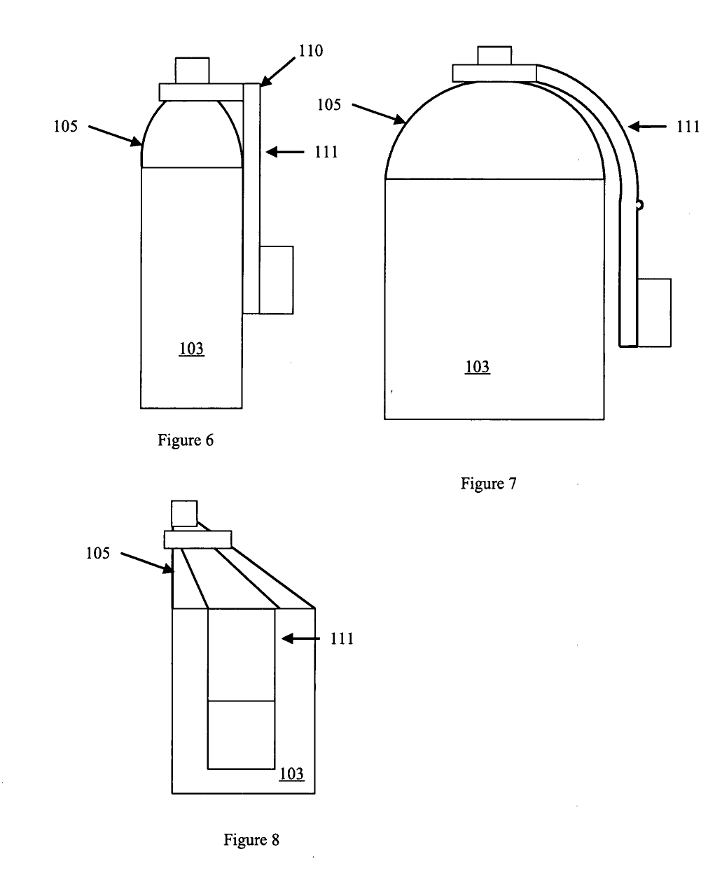

In another embodiment of the present invention, the ring assembly 107 is connected to a hanging arm 111. The hanging arm has an upper end 110 and a lower end 123. The upper end 110 is connected to the ring assembly 107. The connection between the ring assembly 107 and the upper end 110 of the hanging arm 111 can be rigid or hinged. A rigid connection can be utilized with a container 103 that has a neck 105 generally aligned with the body of the container as shown in FIG. 6. Hinged connections can be utilized with containers having a body that has a larger diameter and is not generally aligned with the neck 105 of the container 103. In some embodiments of the present invention the hanging arm 111 is flat (FIG. 6) and in others curved as shown in FIG. 7. A curved hanging arm 111 can be used to fit a container 103 having a curved body and a short neck 105. The hanging arm 111 can extend perpendicularly away from the plane of the ring assembly 107 (FIGS. 3 and 4) or at an angle as shown in FIG. 5.

The lower end 123 is connected to a receptacle 109. In some embodiments of the present invention, receptacle 109 can be connected directly to the ring assembly 107 as described previously. Receptacle 109 can have a number of configurations. One of such configurations is a box as shown in FIGS. 1 through 4 and 6 through 8. The box can have such dimensions as to be able to accommodate a standard sponge, a cleaning brush, and other utensils. The size of the receptacle can vary to accommodate cleaning utensils of different sizes and shapes. Another configuration contains an opening 119 that allows the user to remove the cleaning utensil from the receptacle 109 more easily. Another embodiment of the present invention, as illustrated in FIG. 5, utilizes a clamp 120 instead of a receptacle 109 to hold the cleaning utensil 121. The clamp 120 can be constructed in such a way as to hold the cleaning utensil 121 in place.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A fluid container and holder, comprising:
a fluid container, and
a utensil holder connected to the fluid container; wherein the utensil holder further comprises a utensil receptacle, and
a connector connecting said utensil receptacle to said fluid container.

2. The container and holder of claim 1, wherein the utensil receptacle is detachably attached to said connector.

3. The container and holder of claim 1, wherein the connector comprises an inner ring and an outer ring.

4. The container and holder of claim 3, further comprising an elastomeric membrane within the inner ring.

5. The container and holder of claim 3, wherein the connector has an opening forming a clamp that allows the connecting end to snap onto the fluid container.

6. The container and holder of claim 1, further comprising a hanging arm with an upper end and a lower end, wherein the upper end of the hanging arm is connected to the connector of the utensil holder, and the lower end of the hanging arm is connected to the utensil receptacle.

7. The container and holder of claim 6, wherein the holding arm is hingedly connected to the connector.

8. The container and holder of claim 1, wherein the connector is adjustable to fit various dimensions of the fluid container.

9. The container and holder of claim 1, wherein the utensil receptacle is a box.

10. The container and holder of claim 1, wherein the utensil receptacle is a clamp.

11. The container and holder of claim 1, further comprising a cleaning utensil.

12. The container and holder of claim 11, wherein the cleaning utensil is selected from the group consisting of sponges, brushes, and rags.

13. A utensil holder specifically configured for removable attachment to a fluid container having a tapered neck portion of smaller dimension than a remainder of said fluid container, said utensil holding being particularly configured for removable attachment to said neck portion, said utensil holder comprising:
a utensil receptacle, and
a connector attached to said utensil receptacle and configured for removable attachment to a neck portion of a fluid container.

14. The holder of claim 13, further comprising a hanging arm with a top end and a bottom end, wherein
the top end is connected to the connector, and
the bottom end is connected to the utensil receptacle.

15. The holder of claim 13, wherein the connector comprises an outer ring and an inner ring.

16. The holder of claim 13, further comprising
an elastomeric membrane used to secure the utensil holder to an upper portion of a fluid container.

17. The holder of claim 13, wherein the holding arm is hingedly connected to the connector end.

18. The holder of claim 13, wherein the connector comprises a strap.

19. The holder of claim 13, wherein the receptacle is a box.
